(19) United States
(12) Patent Application Publication
(10) Pub. No.: US 2023/0245538 A1
(43) Pub. Date: Aug. 3, 2023

(54) AUTOMATED PARCEL DELIVERY ROOM

(71) Applicant: Quadient Technologies France, Bagneux (FR)

(72) Inventor: Damien Hasse, Cabrières d'Avignon (FR)

(21) Appl. No.: 17/588,823

(22) Filed: Jan. 31, 2022

(51) Int. Cl. G08B 13/196; G07C 9/00; G07C 9/32; G06Q 10/08

(52) U.S. Cl. CPC G08B 13/19608; G07C 9/00896; G07C 9/32; G06Q 10/0833

(57) ABSTRACT

Systems and methods are provided for automatically tracking the presence and location of parcels in a parcel room and/or in a parcel storage device, using computer vision techniques. A camera and computer vision system track each parcel delivered to the room and monitors the location of each parcel in a parcel storage system. The system automatically identifies recipients and alerts if parcels are removed from the room by unauthorized individuals.

### TECHNICAL FIELD

An automated parcel delivery room is disclosed that uses computer vision and object tracking to allow for automated receipt, management, and tracking of parcels at a common physical location of arbitrary dimension and physical arrangement.

### BACKGROUND

Conventional parcel delivery to individuals or businesses is accomplished in a number of ways. The parcel may be delivered directly to an individual's home or business address and received by the individual or their representative. Alternatively, the parcel may be delivered to a central location or entity, such as a receptionist, central office, mail room, or the like, which then routes the parcel to the individual. More recently, parcel locker systems have become popular in which an automated kiosk-type device includes multiple individual lockers to which parcels may be delivered. The carrier typically then provides the individual with an access code or similar means of accessing the contents of the locker to retrieve the parcel.

### SUMMARY

Systems, devices, and techniques are provided for an automated parcel delivery room. The system may include a camera; a parcel storage device such as a cabinet, shelving unit or the like; and a computer vision system configured to identify new parcels delivered to the parcel delivery room and track placement of parcels on the parcel storage device based upon parcel location information received from the camera. The system may include a user interface, which may be embedded in a physical kiosk, to inform a user of a location of a parcel on the parcel storage device intended for delivery to the user. In operation, systems disclosed herein may automatically scan each parcel to identify a recipient of the parcel based upon a mailing label affixed to the parcel; notify the recipient that the parcel is available to be retrieved; and, based upon information provided by a camera system, track a position of the parcel on a parcel storage device using a computer vision system until the parcel is retrieved.

### BRIEF DESCRIPTION OF THE DRAWINGS

FIG. 1 shows a schematic representation of an automated parcel delivery room as disclosed herein.

FIG. 2 shows a process for automatically receiving parcel deliveries and tracking delivered parcels as disclosed herein.

FIG. 3 shows a schematic representation of a computer system suitable for implementing the systems and techniques disclosed herein.

### DETAILED DESCRIPTION

Existing parcel locker systems suffer from several drawbacks. For one, they require specialized hardware, namely the locker system itself, which may be costly and have very specific space, power, and maintenance requirements. The locker device itself also may not be well-suited to all types of parcels. For example, any parcel locker system can only accommodate parcels of a fixed maximum size. Further, if the individual locker areas are made too large, the locker system may suffer from under-utilization from a space efficiency perspective, if most parcels delivered to the locker device are much smaller than the average locker size. Because parcel lockers devices and individual lockers within them are fixed in size from their initial installation, they also cannot adapt to different conditions, such as holidays or other times when parcel delivery may be more frequent or may include a larger variety of size and shape parcels.

Embodiments disclosed herein provide for a more flexible parcel delivery system in the form of an automated parcel delivery “room.” As used herein, a “room” merely refers to a dedicated parcel delivery space. Typically this space will be in a common area such as a mailroom, but it need not necessarily be structured as a traditional room bounded by physical walls on all sides, as will become apparent from the disclosure. By removing or relaxing the physical structure of a parcel locker, embodiments disclosed herein allow for more flexibility in parcel management, including the ability to handle more parcels in the same space, the ability to automatically monitor a wide variety of parcel sizes and a high number of parcels, and improved usability for both carriers and recipients.

To do so, embodiments disclosed herein use one or more cameras configured to monitor the automated parcel delivery room, in conjunction with a computer vision system that can automatically identify and track parcels delivered by a carrier to a parcel storage device such as a shelf system or the like. Because the system uses computer vision to identify individual parcels, no custom hardware such as a parcel locker is required. Furthermore, the same system may be used to monitor the parcel area, including the parcel storage device, for unauthorized access or removal of parcels.

Although the use of monitoring systems such as security cameras in a mailroom or similar location is known, such use typically is either backward-looking or used for live monitoring by human security personnel for suspicious or malicious activity. For example, a security camera may be used to record activity within a mailroom, so that if a parcel is stolen or mistakenly removed by an unauthorized person, an investigator can review video captured by the camera to identify likely culprits for the malicious or accidental activity. As another example, live monitoring of a mailroom may be performed by human security personnel or the like, who may watch a live view of the mailroom provided by the security system. Such systems are useful for preventing or addressing unauthorized removal of parcels, but they are not connected to any system that can also manage storage, monitoring, and delivery of parcels to the correct recipients. For example, such systems have no link to any system that can either notify recipients when a parcel is delivered, or verify a recipient's identity when the recipient attempts to retrieve a package from the monitored mailroom or other area.

In contrast, embodiments disclosed herein provide for technical improvements over such monitoring systems, as well as technical improvements over conventional parcel locker systems. For example, as disclosed in further detail herein, embodiments allow for real-time monitoring and tracking of individual parcels without the need for fully-enclosed lockers, human monitoring of security cameras, or specialized hardware such as dedicated position sensors, custom storage devices, or the like. Embodiments disclosed herein also provide new industry-specific applications of computer vision systems that previously were not considered by using such vision systems to identify and distinguish parcels in a parcel management system, which in conventional computer vision applications would be considered equivalent, interchangeable, or uninteresting objects, since generally they all are relatively non-descript rectangular objects. Conventional computer vision systems may identify each parcel as, for example, a “box” or generic “object” without recognizing them as objects of interest to be uniquely identified and monitored as disclosed herein.

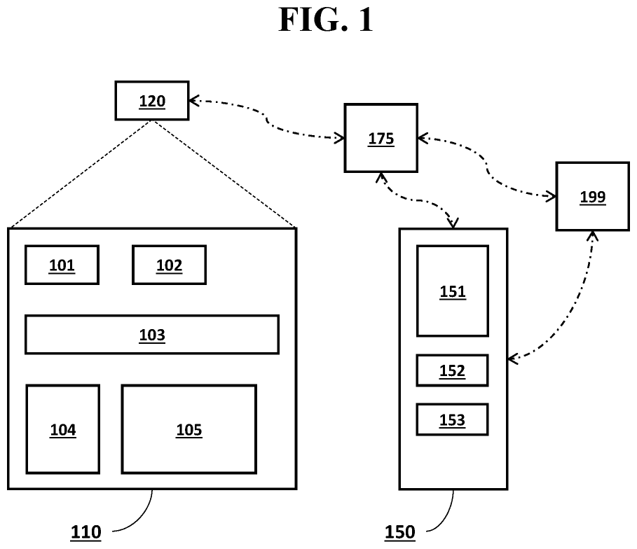

FIG. 1 shows a schematic representation of an automated parcel delivery area as disclosed herein. The system includes a parcel storage device 110, and a camera 120. The camera 120 is in signal communication with a computer vision system 175. The system also may include a kiosk 150 as described in further detail herein, which may include a user interface 151. Alternatively, the user interface 151 may be provided by another computing device such as a tablet or other touch screen device, which may be incorporated in the parcel storage device 110 or may be a stand-alone device.

The parcel storage device 110 may be, for example, a shelf unit or system, a conventional parcel locker (though such may suffer from some of the drawbacks previously described), or simply a dedicated region of a mailroom, reception area, apartment complex, home, or business, or the like. The parcel storage device 110 may be configured to store multiple parcels 101, 102, 103, 104, 105. The parcels 101-105 may have varying dimensions, weights, and/or other physical characteristics. Notably, in contrast to conventional parcel locker systems, the parcel storage device 110 does not impose significant physical limitations on the parcel dimensions, such as requiring that each parcel fit into a standardized locker in a parcel locker system. The parcel storage device may provide multiple shelves that are more specifically designed and arranged to store a wide range of parcel sizes and shapes as shown. The parcel storage system also may be configurable and/or expandable. For example, the parcel storage device may be a shelf system that has adjustable-height shelves, thereby allowing for the device 110 to be reconfigured if it is not capable of storing a particular parcel at the time it is delivered by a carrier.

The system also may include a camera 120. As used herein, the “camera” 120 may be a visual wavelength camera such as a conventional digital camera, which may also be capable of detecting other wavelengths such as infra-red, ultraviolet, and the like. The camera 120 also may include other related sensors, such as motion sensors, active and/or passive infra-red sensors, and the like, to allow for finer detection of people and objects in the area.

The camera 120 may operate in conjunction with a computer vision system 175. The computer vision system may process stored and/or live video captured by the camera 120 to identify objects including parcels 101-105, the parcel storage device 110, people in the area, and the like. The computer vision system 175 may be part of a larger computer system or network, for example where some processing tasks are offloaded to a remote video processing system or the like. The computer vision system 175 also may be integrated with other related computer systems, such as a security or premises management system, a smart home or similar system, or the like. In some cases, the camera 120 may include multiple individual cameras arranged around the mailroom or other location in which the system is arranged, for example to provide sufficient camera coverage of a larger area. As used herein, a “camera” thus may refer to a camera system that includes multiple individual cameras unless explicitly indicated otherwise or required by context.

The camera 120 and computer vision system 175 may perform a variety of functions. In some embodiments, they may perform initial identification and scanning of parcels delivered by a carrier or other deliverer to the parcel storage device 110, for example by identifying and processing a machine-readable and/or text label on the parcel. For example, the parcel may include a bar code, QR code, or the like, an image of which may be captured from a video feed provided by the camera 120 and processed by the computer vision system 175 to identify a recipient. The system may perform such functions without requiring additional action or input from the carrier, for example where the label is visible to the on the parcel when the parcel is brought into the parcel delivery room by the carrier. The room also may include instructions such as printed signs, recorded messages, or the like, which instruct the carrier to position the parcel so that the shipping label is visible to a camera 120. An indicator such as an audio indicator, green/red lighting, visible user interface, or the like may be used to indicate to the carrier when a shipping label has been successfully captured and/or processed by the system. The delivery room may include other access controls, such as card readers, NFC readers, electronic or physical key entry, and the like, to guard against unauthorized access.

After a parcel has been delivered to the parcel delivery room and identified by the system, either as disclosed above or via a kiosk as described in further detail below, the system may automatically track the position of the parcel in the parcel room, including a position of the parcel on the parcel storage device 110. Tracking may be performed continuously or intermittently, at a sufficiently frequent interval that the system is essentially always aware of the location and position of the parcel. To track the location of a parcel, the computer vision system 175 may assign a unique identifier to the parcel based upon information derived from the imaging data received from the camera 120. For example, the vision system 175 may use the height, width, depth, weight, and/or color of the parcel to assign an identifier to the parcel. The system also may use other physical attributes, such as unique identifying features, the position and size of the mailing label if already identified, and patterns caused by tape, packaging or other materials on the parcel. The same identifying information also may be used to track the parcel as it is placed on the parcel storage device 110 and until it is removed by a recipient. This tracking allows the system to know if a parcel has been removed from the room entirely or if it merely moved from one location in the room or on the storage device 110 to another. The computer vision system may be able to any number of parcels in the room using any suitable image analysis techniques, such as edge detection, object detection and tracking, image classification, object segmentation, and the like, typically using various forms of machine learning as are known in the computer vision art.

When a user interface, such as a display screen and/or kiosk is used, the system also may indicate to a carrier where on the parcel storage device 110 a parcel 101-105 should be placed. For example, the system may know the horizontal and vertical space available on each shelf of a multi-shelf unit, as well as the maximum weight capacity of the shelf and the other parcels (if any) already arranged on the shelf, which are already being tracked by the system. In some embodiments, the device 110 and/or a kiosk 150 as described below may include one or more sensors such as weight sensors, to automatically determine the weight of the new parcel and previous parcels already arranged on the parcel storage device 110.

Some embodiments may use a kiosk or equivalent device 150. The kiosk may include a user interface 151, a parcel scanner 152, and/or a weight sensor 153. The kiosk 150 may be implemented as a single integrated device, or it may be provided as multiple separate devices that perform the associated functions disclosed herein. The user interface 151 may provide instructions to, and receive input from, carriers, parcel recipients, and others. The parcel scanner 152 may include a barcode reader, QR code reader, optical character recognition (OCR) system, or the like, to identify and process recipient information on a mailing label. The weight sensor 153, such as a conventional parcel scale, may be used to obtain a weight of a parcel. In operation, a carrier may bring a parcel to be delivered to the kiosk and present a mailing label affixed to the parcel to the parcel scanner 152. The user interface 151 may provide instructions on how to do so, including a live “guide” image provided by a camera included in the kiosk 150 that provides a live image for display on the user interface. The guide image may include an indicator such as an outline or highlighted rectangle to show where the mailing label should be placed for proper scanning by the parcel scanner 152.

The parcel scanner 152 may read the mailing label and obtain appropriate recipient information therefrom. For example, it may read a barcode or QR code having encoded recipient information or a parcel identifier that can be used to obtain recipient information, such as from a remote carrier database. Once a recipient is determined, the kiosk may verify that the recipient is registered with the automated parcel delivery room, for example by consulting a recipient database for the location. As a specific example, the recipient database may include a list of all current residents of an apartment building, all tenants of a commercial building, or the like. If the recipient is currently registered with the system, the kiosk may provide instruction via the user interface regarding where to place the parcel in the parcel storage device 110. If the recipient is not registered, the kiosk may indicate via the user interface that the parcel should be returned to the sender or otherwise processed by the carrier as usual for an incorrect recipient. In some embodiments, the kiosk may indicate that the parcel scanning and recipient lookup process should be repeated and will repeat the process to verify that the correct recipient has been identified and to verify that the recipient is or is not registered with the system. The kiosk may include other components, either separately or as a part of the parcel scanner 152, such as a card reader, near-field communication (NFC) device, or the like, which may be used to identify recipients, couriers or other individuals making deliveries, or suitably-encoded parcels.

Once a recipient is identified and it is determined that the recipient should receive parcels at the automated delivery room, the kiosk 150 may indicate to the carrier via the user interface 151 a location on the parcel storage device 110 where the parcel should be placed. This may be done, for example, via voice or text, by showing an image of the parcel storage device 110 that indicates the appropriate location, or via indicators such as controllable lights, digital labels, built-in illumination, or other similar parcel position indicator on the device 110 itself. Because the system is able to track the position of each parcel on the parcel storage device 110 via the camera 120 and computer vision system 175, it may be able to identify a suitable location for a newly-delivered parcel even where parcels already present on the device 110 have been previously moved from their original placement, such as by other carriers, recipients of other parcels, or third parties. Indicated locations also may take into account the physical limitations of various parts of the storage device 110. For example, lower shelves of a shelf unit may have a higher weight rating and therefore are better suited to storage of heavier parcels, while upper shelves may have smaller physical clearances and thus may be better suited for storing physically smaller parcels.

When a new parcel is delivered to the system and the recipient has been determined to be a registered recipient (i.e., is present and available to receive parcels at the location associated with the delivery room), the kiosk or other computerized component of the system may notify the recipient of the presence of the parcel. The recipient then may retrieve the parcel from the storage device 110. In some embodiments, the computer vision system 175 may automatically identify the recipient upon entry to the parcel delivery room and automatically match the recipient to any parcels delivered for the recipient. For example, recipients may have identification badges with unique bar codes, QR codes, or other identifiers that allow the system to know the identity of each recipient and determine which parcel(s) have been delivered for the recipient. As another example, recipients may be registered in a facial recognition portion of the computer vision system 175 that allows for automatic identification of each registered recipient via image data obtained by the camera 120 when individuals enter the delivery room. Alternatively, a recipient may enter an access code or other data via the user interface 151 that was previously provided to the recipient by the system to indicate they are retrieving a specific parcel. When the recipient removes the appropriate parcel from the storage device 110, the system may stop tracking that particular parcel via the camera 120 and computer vision system 175. Conversely, if a recipient or other individual attempts to remove a parcel that is not known to be associated with the individual, an alert may be generated to prevent or otherwise address such removal. For example, an audible and/or visual alarm may be triggered, an alert message may be sent to security personnel or other appropriate individuals, or the like.

In some embodiments, the user interface 151, parcel scanner 152, and/or weight sensor 153 also may be provided as separate components or the same functionality described herein with respect to those components may be provided by other components of the system. For example, as previously disclosed, a camera 120 and computer vision system 175 may provide parcel scanning functions as disclosed herein.

In some embodiments, other computerized data systems 199 may be used. For example, the external systems 199 may include a recipient database that the automated delivery room accesses to verify that a recipient is a current tenant of a residential or commercial building as previously disclosed. As another example, the systems 199 may include carrier data systems that provide information about parcels based on mailing labels, such as where a mailing label is read and recipient data is requested from the carrier system 199 based upon the mailing label. As another example, the systems 199 may include a remote coordination system for the automated delivery room itself, such as where multiple such rooms are centrally managed to provide software updates, recipient data, or the like.

As a specific example of operation of a system as disclosed herein, prior to delivery of parcel 105, parcels 101-104 may be present on the parcel storage device 110. A carrier may bring parcel 105 into the automated delivery room where it is scanned by the camera 120 and computer vision system 175 or the parcel scanner 152. From data obtained during the scan, the system may obtain recipient information from the parcel, such as from a mailing label, and identify a recipient registered with the system. Via the user interface 151 and/or indicators on the parcel storage device 110, the system may indicate a suitable location for the carrier to place the parcel 105. The suitable location may be determined based on the physical characteristics of the parcel and available space on the parcel storage device 110. If a suitable location does not exist, the system may indicate via the user interface 151 that the carrier should move one or more parcels to different locations on the device 110, thereby creating a suitable location for the new parcel 105. The system also may send a notification to the recipient indicating that the parcel is available to be retrieved. The notification also may include an access code or other means for the recipient to identify themselves and/or the parcel being retrieved. Until the parcel is retrieved by the recipient, the system may track the position of the parcel 105 in the storage device 110 or elsewhere in the room by using data received from the camera 120 and processed by the computer vision system 175. If an unauthorized person, such as anyone other than the recipient or anyone that does not first provide the access code, attempts to remove the parcel from the room, the system may activate an alarm as previously disclosed. When the recipient arrives to retrieve the parcel 105, they may be identified by the system either via the camera 120 and computer vision system 175 and/or the kiosk 150, such as by the recipient providing the access code previously sent to them. The recipient then may remove the parcel 105 without triggering an alarm or other alert that would indicate an unauthorized removal of a parcel.

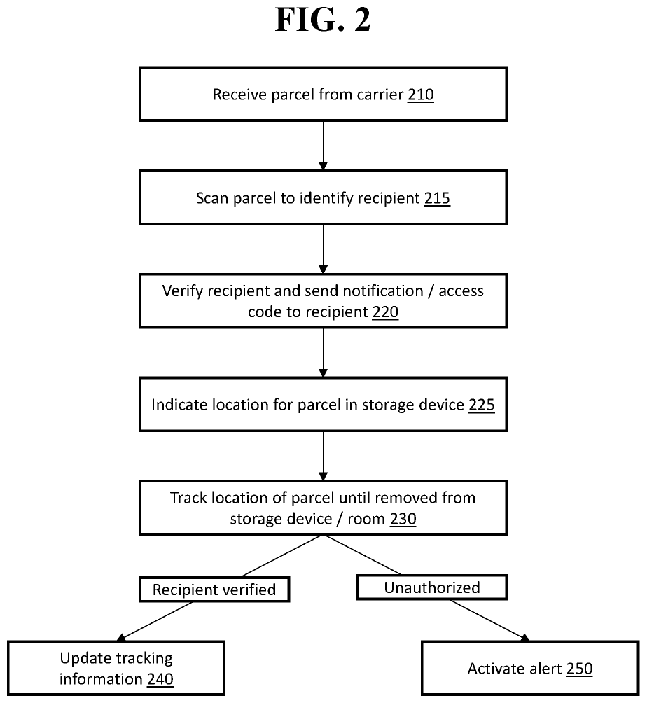

FIG. 2 shows an example process of operation of an automated delivery room as disclosed herein. At 210, a parcel may be delivered by a carrier. The parcel may be scanned at 215, as previously disclosed, to identify recipient information such as on a mailing label. The recipient information may be obtained from plain text via OCR, decoded from a QR code or bar code, or the like. The scan may be performed by a dedicated parcel scanner, which may be integrated with a kiosk or other device, or it may be performed via a camera and computer vision system as previously disclosed.

At 220, the system may verify that the indicated recipient is a correct recipient for the particular room, such as by consulting a tenant database or the like to determine that the recipient is a current tenant of a residential or commercial building associated with the delivery room, is registered with the room, or the like. The system also may send a notification and/or access code to the recipient as previously disclosed.

At 225, the system may indicate to the carrier a suitable location in a parcel storage device to place the parcel. For example, a user interface on a kiosk or the parcel storage device itself may provide a visual indication of a suitable location for the parcel.

At 230, the system may track the location of the parcel within the room and/or the parcel storage device. For example, the system may use a camera and a computer vision system to identify the parcel as an object in a video feed and continuously monitor the position of the identified object within the room. The location tracking may be used to determine if a parcel is being removed from the room, even if the parcel has previously been moved within the room or the storage device. The parcel may be tracked in this manner until it is removed from the room.

If the parcel is removed by the recipient or another individual that provides the access code sent to the recipient at 220, tracking information may be updated at 240 to remove the parcel from a list or database of tracked parcels in the room. If the parcel is otherwise removed, an alert may be activated at 250 as previously disclosed.

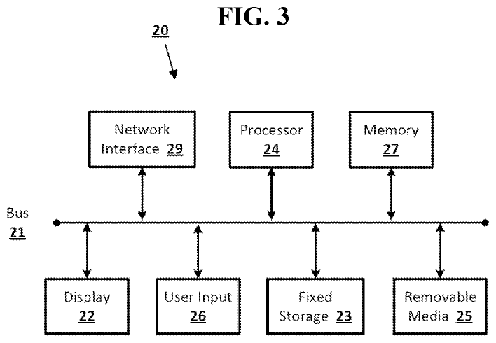

Embodiments disclosed herein may be implemented on a range of computer systems. FIG. 3 shows an example of a general- or specific-purpose computing device 20 suitable for implementing embodiments disclosed herein. For example, the device 20 may be used to implement a computer vision system, user kiosk, or other devices disclosed herein. The device 20 may be, for example, a desktop or laptop computer, a mobile computing device such as a smart phone, tablet, or the like, or an embedded computing system, such as a system embedded in a parcel locker that is accessible by end users only through a limited-function interface. The device 20 may include a bus 21 which interconnects components of the computer 20, such as a central processor 24, a memory 27 such as Random Access Memory (RAM) and/or Read Only Memory (ROM), flash RAM, or the like, a user display 22 such as a display screen, a user input interface 26, which may include one or more controllers and associated user input devices such as a touch screen, code entry keypad as disclosed herein, or the like, a fixed storage 23 such as a hard drive, flash storage, and the like. The device may include a removable media component 25 operative to control a flash media reader or the like, for example to allow for local administrators to load updated software into a parcel locker device as disclosed herein. The device may include a network interface 29 operable to communicate with remote devices via a suitable network connection such as via the Internet. For example, a parcel locker as disclosed herein may communicate with a central parcel locker system and/or a property management system as disclosed herein. The network interface 29 may provide such connection using any suitable technique and protocol as will be readily understood by one of skill in the art, including digital cellular telephone, Wi-Fi, Bluetooth(R), near-field, and the like. For example, the network interface 29 may allow the device to communicate with other computers via one or more local, wide-area, or other communication networks, as described herein.

The bus 21 allows data communication between the central processor 24 and one or more memory components 25, 27, which may include RAM, ROM, and other memory, as previously noted. Applications resident with the computer 20 are generally stored on and accessed via a computer readable storage medium.

More generally, embodiments disclosed herein may include or be embodied in the form of computer-implemented processes and apparatuses for practicing those processes. Embodiments also may be embodied in the form of a computer program product having computer program code containing instructions embodied in non-transitory and/or tangible media, such as hard drives, solid state drives, or any other machine readable storage medium, such that when the computer program code is executed by a computer processor, the processor becomes an apparatus for practicing the embodiments. When implemented on a general-purpose microprocessor, the computer program code may configure the microprocessor to become a special-purpose device, such as by creation of specific logic circuits as specified by the instructions.

Embodiments may be implemented using hardware that may include a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. Other processors, such as GPUs, NVUs, and the like may be used, as well as any associated processing systems and storage. The memory may store instructions adapted to be executed by the processor to perform the techniques according to embodiments of the disclosed subject matter.

The foregoing description, for purpose of explanation, has been described with reference to specific embodiments. However, the descriptions provided herein are not intended to be exhaustive or to limit embodiments of the disclosed subject matter to the precise forms disclosed. The illustrative embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A parcel delivery room management system, comprising:
a camera;
a parcel storage device;
a computer vision system configured to:
identify new parcels delivered to the parcel delivery room; and
track placement of parcels on the parcel storage device based upon parcel location information received from the camera; and
a user interface configured to inform a user of a location of a parcel on the parcel storage device intended for delivery to the user.

2. The system of claim 1, wherein the computer vision system is further configured to obtain recipient information from parcels.

3. The system of claim 1, further comprising:
a parcel scanner configured to obtain recipient information from parcels.

4. The system of claim 3, wherein the parcel scanner comprises a barcode reader, QR code reader, optical character recognition (OCR) system, or a combination thereof.

5. The system of claim 1, further comprising an alarm configured to alert when a parcel is removed by an incorrect recipient based upon information received from the computer-vision system, the delivery kiosk, or a combination thereof, the alert comprising an audible alert, a visual alert, a notification sent to a property manager, or a combination thereof.

6. The system of claim 3, further comprising a kiosk, wherein the kiosk comprises the parcel scanner and/or the user interface.

7. The system of claim 1, further comprising a kiosk, wherein the kiosk comprises the user interface.

8. The system of claim 1, wherein the parcel storage device comprises one or more weight sensors.

9. The system of claim 1, wherein the parcel storage device comprises a plurality of parcel position indicators that indicate a location on the parcel storage device where a parcel is to be placed.

10. A method comprising:
scanning a first parcel to identify a recipient of the parcel based upon a mailing label affixed to the parcel;
notifying the recipient that the parcel is available to be retrieved;
based upon information provided by a camera system, tracking a position of the parcel on a parcel storage device using a computer vision system until the parcel is retrieved.

11. The method of claim 10, further comprising:
indicating an initial position on the parcel storage device for a carrier to place the parcel.

12. The method of claim 10, wherein the step of tracking the position of the parcel on the parcel storage device comprises updating a stored indication of the position of the parcel in response to the parcel being moved within the parcel storage device.

13. The method of claim 12, wherein the stored indication of the position of the parcel is associated with a unique identifier of the parcel.

14. The method of claim 13, wherein the unique identifier is based at least in part on one or more physical characteristics of the parcel.

15. The method of claim 10, further comprising:
responsive to the parcel being removed from the parcel storage device, sounding an alarm.

16. The method of claim 10, further comprising:
providing an access code to the recipient;
subsequent to the parcel being placed on the parcel storage device, receiving the access code; and
responsive to receiving the access code, allowing the parcel to be removed from the parcel storage device without sounding an alarm.

17. The method of claim 16, wherein the step of receiving the access code is performed using a kiosk comprising a user interface.

18. The method of claim 17, wherein the kiosk comprises a scanner used to perform the step of scanning the parcel.

19. The method of claim 16, wherein the access code is received via a user interface in signal communication with the computer vision system.

20. The method of claim 10, wherein the step of scanning the parcel is performed using a barcode reader, QR code reader, optical character recognition (OCR) system, or a combination thereof.
